(19) United States
(12) Patent Application Publication
(10) Pub. No.: US 2026/0099416 A1
(43) Pub. Date: Apr. 9, 2026

(54) Method for Determining at Least One Change Point in a Time Series of Sensor Values

(71) Applicant: Robert Bosch GmbH, Stuttgart (DE)

(72) Inventors: Johannes HAUG, Rottenburg (DE); Michiel RUELENS, Karlsruhe (DE); Stefan Patrick LINDT, Ettlingen (DE)

(21) Appl. No.: 18/912,861

(22) Filed: Oct. 11, 2024

(30) Foreign Application Priority Data
Oct. 19, 2023 (DE) 10 2023 210 335.4

(51) Int. Cl. G06F 11/30

(52) U.S. Cl. CPC G06F 11/3089; G06F 11/3079

(57) ABSTRACT

A method for ascertaining at least one change point in a time series of sensor values. The method includes: providing a time series of sensor values and dividing the time series of sensor values into at least one evaluation window; for each of the at least one evaluation window, ascertaining at least two different characteristics of the sensor values contained in the corresponding evaluation window; for each of the at least one evaluation window, ascertaining whether the sensor values contained in the corresponding evaluation window have at least one change point based on the at least two different characteristics of the sensor values contained in the corresponding evaluation window; and providing information about ascertained change points.

### FIELD

The present invention relates to a method for ascertaining at least one change point in a time series of sensor values, with which method change points can be ascertained in continuous multi-dimensional time series of sensor values, or a plurality of different types of change points can be ascertained simultaneously.

### BACKGROUND INFORMATION

A change point is understood to be a significant or sudden, in particular unexpected change in a signal, for example in a time series of sensor values. Such change points can, for example, indicate anomalies, such as corresponding anomalies in a manufacturing process.

A sensor, which is also referred to as a detector, (measured variable or measuring) pickup or (measuring) probe, is a technical component which can detect certain physical or chemical properties and/or the material nature of its surroundings qualitatively or quantitatively as a measured variable.

Such sensors are often designed to continuously measure values, such as pressure, temperature, vibration or acceleration values during a manufacturing process. The continuously measured values form a time series of sensor values, or a corresponding time series is output at the output of a corresponding sensor in the form of an electrical or digitized signal.

For example, in order to be able to identify anomalies, in particular anomalies in a manufacturing process, corresponding time series of sensor values are often analyzed and it is ascertained whether they have change points. The disadvantage here, however, is that conventional methods for change point detection are not designed to ascertain change points in continuous multi-dimensional time series of sensor values, or to simultaneously evaluate a plurality of different characteristics of time series of sensor values, based on which in particular different types of change points can be ascertained.

German Patent Application No. DE 10 2022 200 284 A1 describes a method for evaluating a data-based sensor model for determining a change point time in a sensor signal time series, wherein an evaluation signal time series is provided in an evaluation time window of a sensor signal time series, sensor signal sections which are shifted in time from one another or offset from one another by a number of sampling steps are ascertained from the evaluation signal time series, wherein the sensor signal sections have a shorter length than the evaluation signal time series, one or more frequency contributions are ascertained from the sensor signal sections, and wherein the frequency contributions are evaluated in a trained data-based sensor model in order to determine a change point time within the evaluation time window.

### SUMMARY

An object of the present invention is to provide an improved method for identifying change points in a time series of sensor values.

The object may be achieved by a method for identifying at least one change point in a time series of sensor values according to certain features of present invention.

The object is moreover also achieved by a system for identifying at least one change point in a time series of sensor values according to certain features of the present invention.

According to one example embodiment of the present invention, the object is achieved by a method for ascertaining at least one change point in a time series of sensor values. According to an example embodiment of the present invention, a time series of sensor values is provided and the time series of sensor values is divided into at least one evaluation window, for each of the at least one evaluation window at least two different characteristics of the sensor values contained in the corresponding evaluation window are ascertained, for each of the at least one evaluation window it is ascertained, based on the at least two different characteristics of the sensor values contained in the corresponding evaluation window, whether the sensor values contained in the corresponding evaluation window have at least one change point, and wherein information about ascertained change points is provided.

An evaluation window is understood to be a finite and continuous or temporally related section of a continuous time series.

A characteristic is further understood to be a feature or property, in particular a statistical property of the sensor values contained in the corresponding section of the time series.

Different characteristics are understood to mean in particular that each of the characteristics has different advantages for the detection of change points, in particular that each of the characteristics is suitable for detecting other change points.

The fact that at least two different characteristics, in particular at least two characteristics, wherein each of the at least two characteristics is suitable for detecting other change points, are ascertained and evaluated or analyzed has an advantage that change points in continuous multi-dimensional time series of sensor values, or different types of change points, can be ascertained simultaneously with one method. This can, for example, ensure that anomalies in manufacturing processes can be identified as early as possible.

The fact that only individual evaluation windows are evaluated at a time has the advantage that the number of data or information evaluated at the same time and thus also the resources required for this, in particular memory and/or processor capacities, can be significantly reduced.

Overall, an improved method for identifying change points in time series of sensor values is provided.

According to an example embodiment of the present invention, the step of ascertaining, for each of the at least one evaluation window, whether the sensor values contained in the corresponding evaluation window have at least one change point can comprise comparing information based on at least one of the at least two characteristics with at least one limit value.

A limit value is understood to be a value which can indicate significant or sudden, in particular unexpected changes in the corresponding sensor signal.

This means that change points can be easily ascertained using conventional methods or comparisons with limit values, without the need for complex and resource-intensive adjustments.

In addition, according to an example embodiment of the present invention, the step of ascertaining, for each of the at least one evaluation window, whether the sensor values contained in the corresponding evaluation window have at least one change point can comprise applying a machine learning algorithm, which is trained to ascertain change points in information based on at least one characteristic of sensor values, to information based on at least one of the at least two characteristics.

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models by means of which data can be classified, for example.

This has the advantage that the change points are ascertained automatically in a simple manner, with high accuracy and independently of expert knowledge.

In one example embodiment of the present invention, the method further comprises a step of combining, for each of the at least one evaluation window, at least a part of the at least two different characteristics into a common characteristic, and wherein the step of respectively ascertaining, for each of the at least one evaluation window, whether the sensor values contained in the corresponding evaluation window have at least one change point comprises ascertaining whether the sensor values contained in the corresponding evaluation window have at least one change point based on the common characteristic.

A common characteristic is understood here to be the sum of at least a part of the at least two different characteristics, i.e., the data or information representing the part of the at least two different characteristics, or an aggregation of the part of the at least two different characteristics.

The fact that whether at least one change point exists is ascertained based on the common characteristic and not based on the at least two different characteristics separately has the advantage that the corresponding analysis or evaluation is considerably simplified, in particular for a corresponding expert.

Furthermore, according to an example embodiment of the present invention, the step of ascertaining, for each of the at least one evaluation window, whether the sensor values contained in the corresponding evaluation window have at least one change point can comprise applying a normalization method to information based on at least one of the at least two characteristics.

A standardization procedure is understood to be a procedure which is used to unify or standardize the values or information representing the corresponding characteristic, thereby improving the comparability of the corresponding characteristic.

This has the advantage that the identification of change points can be further simplified.

The time series of sensor values can also be, in particular, a time series of sensor values measured during an execution of a manufacturing process and representing the manufacturing process.

A manufacturing process is understood to be a standardized workflow for manufacturing a product.

In particular, anomalies in the manufacturing process, for example in the control of individual workstations or machines, can be identified based on detected change points. Based on the corresponding identified anomalies, components which have been manufactured accordingly can then be automatically discarded.

The manufacturing process can, for example, be a workflow for manufacturing a populated semiconductor wafer.

A further example embodiment of the present invention also provides a method for identifying anomalies in a manufacturing process, wherein the method comprises detecting a time series of sensor values representing the manufacturing process during execution or during operation of the manufacturing process, ascertaining at least one change point in the identified time series of sensor values by means of a method described above for ascertaining at least one change point in a time series of sensor values, and examining the at least one change point in order to identify anomalies in the manufacturing process.

Thus, a method for identifying anomalies in a manufacturing process is provided, which is based on change points identified by an improved method for identifying change points in time series of sensor values. The fact that at least two different characteristics, in particular at least two characteristics, wherein each of the at least two characteristics is suitable for detecting other change points, are ascertained and evaluated or analyzed has the advantage that change points in continuous multi-dimensional time series of sensor values, or different types of change points, can be ascertained simultaneously with one method. This can, for example, ensure that anomalies in manufacturing processes can be identified as early as possible. The fact that only individual evaluation windows are evaluated at a time has the advantage that the number of data or information evaluated at the same time and thus also the resources required for this, in particular memory and/or processor capacities, can be significantly reduced.

A further example embodiment of the present invention also provides a system for ascertaining at least one change point in a time series of sensor values, wherein the system has at least one sensor for detecting a time series of sensor values and at least one computing unit for processing the detected time series of sensor values, and wherein the system is designed to carry out an above-described method for ascertaining at least one change point in a time series of sensor values.

Thus, an improved system for ascertaining change points in a time series of sensor values is provided. The fact that at least two different characteristics, in particular at least two characteristics, wherein each of the at least two characteristics is suitable for detecting other change points, are ascertained and evaluated or analyzed has the advantage that change points in continuous multi-dimensional time series of sensor values, or different types of change points, can be ascertained simultaneously with one method. This can, for example, ensure that anomalies in manufacturing processes can be identified as early as possible. The fact that only individual evaluation windows are evaluated at a time has the advantage that the number of data or information evaluated at the same time and thus also the resources required for this, in particular memory and/or processor capacities, can be significantly reduced.

A further example embodiment of the present invention also provides a system for identifying anomalies in a manufacturing process, wherein the system comprises at least one sensor for detecting a time series of sensor data representing the manufacturing process during an execution of the manufacturing process, an ascertainment unit which is designed to ascertain at least one change point in the detected time series of sensor values using an above-described system for ascertaining at least one change point in a time series of sensor values, and an examination unit which is designed to examine the at least one change point in order to identify anomalies in the manufacturing process.

Thus, a system for identifying anomalies in a manufacturing process is provided, which is based on change points identified by an improved system for identifying change points in time series of sensor values. The fact that at least two different characteristics, in particular at least two characteristics, wherein each of the at least two characteristics is suitable for detecting other change points, are ascertained and evaluated or analyzed has the advantage that change points in continuous multi-dimensional time series of sensor values, or different types of change points, can be ascertained simultaneously with one method. This can, for example, ensure that anomalies in manufacturing processes can be identified as early as possible. The fact that only individual evaluation windows are evaluated at a time has the advantage that the number of data or information evaluated at the same time and thus also the resources required for this, in particular memory and/or processor capacities, can be significantly reduced.

In summary, it can be stated that the present invention provides a method for ascertaining at least one change point in a time series of sensor values, with which method change points can be ascertained in continuous multi-dimensional time series of sensor values, or a plurality of different types of change points can be ascertained simultaneously.

The described embodiments and developments o the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the example embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 shows a flow chart of a method for ascertaining at least one change point in a time series of sensor values according to example embodiments of the present invention.

FIG. 2 shows part of a method for ascertaining at least one change point in a time series of sensor values according to embodiments of the present invention.

FIG. 3 shows a schematic block diagram of a system for ascertaining at least one change point in a time series of sensor values according to example embodiments of the present invention.

### DETAILED DESCRIPTION OF EXAMPLE EMBODIMENTS

In the figures, identical reference signs denote identical or functionally identical elements, parts or components, unless stated otherwise.

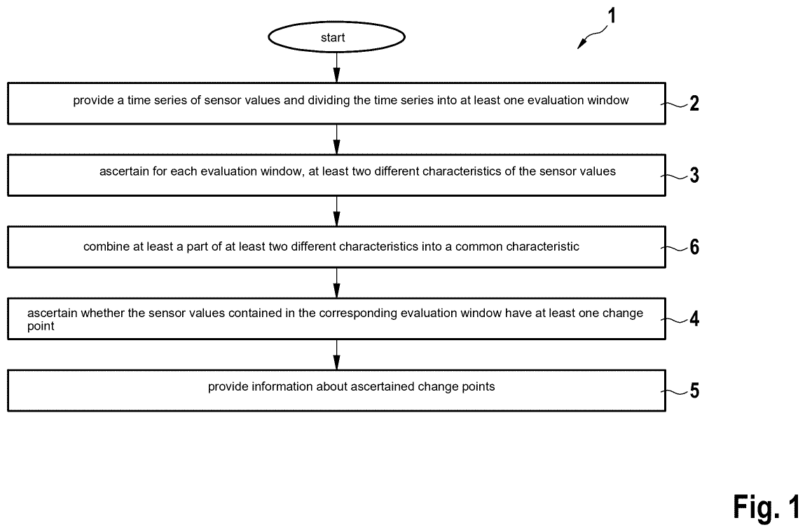

FIG. 1 shows a flow chart of a method for ascertaining at least one change point in a time series of sensor values 1 according to embodiments of the present invention.

Sensors are often designed to continuously measure values, such as pressure, temperature, vibration or acceleration values during a manufacturing process. The continuously measured values form a time series of sensor values, or a corresponding time series is output at the output of a corresponding sensor in the form of an electrical or digitized signal.

For example, in order to be able to identify anomalies, in particular anomalies in a manufacturing process, corresponding time series of sensor values are often analyzed and it is ascertained whether they have change points. The disadvantage here, however, is that conventional methods for change point detection are not designed to ascertain change points in continuous multi-dimensional time series of sensor values, or to simultaneously evaluate a plurality of different characteristics of time series of sensor values, based on which in particular different types of change points can be ascertained.

FIG. 1 shows a method 1 which comprises a step 2 of providing a time series of sensor values and dividing the time series of sensor values into at least one evaluation window, a step 3 of ascertaining, for each of the at least one evaluation window, at least two different characteristics of the sensor values contained in the corresponding evaluation window, a step 4 of ascertaining, for each of the at least one evaluation window, based on the at least two different characteristics of the sensor values contained in the corresponding evaluation window, whether the sensor values contained in the corresponding evaluation window have at least one change point, and a step 5 of providing information about ascertained change points.

The fact that at least two different characteristics, in particular at least two characteristics, wherein each of the at least two characteristics is suitable for detecting other change points, are ascertained and evaluated or analyzed has the advantage that change points in continuous multi-dimensional time series of sensor values, or different types of change points, can be ascertained simultaneously with one method. This can, for example, ensure that anomalies in manufacturing processes can be identified as early as possible.

The fact that only individual evaluation windows are evaluated at a time has the advantage that the number of data or information evaluated at the same time and thus also the resources required for this, in particular memory and/or processor capacities, can be significantly reduced.

Overall, an improved method 1 for identifying change points in time series of sensor values is provided.

In particular, a method 1 is provided which is designed to ascertain, in a simple manner and without the need for complex and resource-intensive adjustments, when significant deviations from normal behavior occur, i.e., a time of a change point.

Method 1 is characterized by its flexibility, easy interpretability and effectiveness. The method can be used both online and offline to ascertain any type of change. In addition, the characteristics are very informative and can be evaluated in a simple way.

The time series can have a random length not defined in advance, wherein individual evaluation windows can be analyzed immediately after a time period corresponding to the corresponding time window has elapsed. Furthermore, a time series can also be divided into individual evaluation windows after the complete time series has been received and the individual application windows can then be analyzed. The individual time windows can also be the same length, although it is also possible for individual application windows to have different lengths.

Furthermore, no requirements or specifications are necessary regarding the data distribution or the number of change points.

Depending on the application, providing sensor values can also comprise oversampling and/or undersampling.

The at least two different characteristics can in particular be statistical properties, for example a variance, a spectrum or a deviation from a mean value.

A total value can be ascertained for the entire evaluation window, i.e., the corresponding values in the evaluation window are summed up. A value corresponding to a left boundary of the evaluation window and a value corresponding to a right boundary of the evaluation window can then be subtracted from this total value in order to ascertain an overall change in the corresponding characteristic within the corresponding evaluation window.

According to the embodiments of FIG. 1, step 4 of ascertaining, for each of the at least one evaluation window, whether the sensor values contained in the corresponding evaluation window have at least one change point comprises comparing information based on at least one of the at least two characteristics with at least one limit value.

In particular, an ascertained overall change in the corresponding characteristic within the corresponding evaluation window can be compared with at least one limit value.

The at least one limit value can be defined in advance or can be based on corresponding values from previous evaluation windows, for example corresponding overall changes within previous evaluation windows.

Corresponding results, i.e., positions of change points within the corresponding evaluation window, can be further output in the form of Boolean vectors.

According to the embodiments of FIG. 1, step 4 of ascertaining, for each of the at least one evaluation window, whether the sensor values contained in the corresponding evaluation window have at least one change point further comprises applying a machine learning algorithm, which is trained to ascertain change points in information based on at least one characteristic of sensor values, to information based on at least one of the at least two characteristics.

The machine learning algorithm can be trained, for example, based on corresponding labeled training data, for example training data which represents relationships between information representing a characteristic and change points.

According to the embodiments of FIG. 1, the method further comprises a step 6 of combining, for each of the at least one evaluation window, at least a part of the at least two different characteristics into a common characteristic, wherein the step 4 of ascertaining, for each of the at least one evaluation window, whether the sensor values contained in the corresponding evaluation window have at least one change point comprises ascertaining whether the sensor values contained in the corresponding evaluation window have at least one change point based on the common characteristic.

In particular, depending on the application, individual characteristics can be combined into a common characteristic and other characteristics can be evaluated separately.

In addition, the individual aggregated characteristics can be weighted when combined, for example based on their respective importance or influence on the corresponding application.

According to the embodiments of FIG. 1, the time series of sensor values is further a time series of sensor values measured during an execution of a manufacturing process and representing the manufacturing process.

In particular, this can be a time series of pressure, temperature, vibration or acceleration values during the manufacturing process, for example of a workstation or machine.

Based on the ascertained change points, it is then possible to check, for example, whether anomalies exist. If an anomaly is identified, corresponding manufactured products can be automatically discarded. Furthermore, an alarm can also be triggered automatically to signal an expert to analyze the corresponding anomaly and its impact on the production process in more detail.

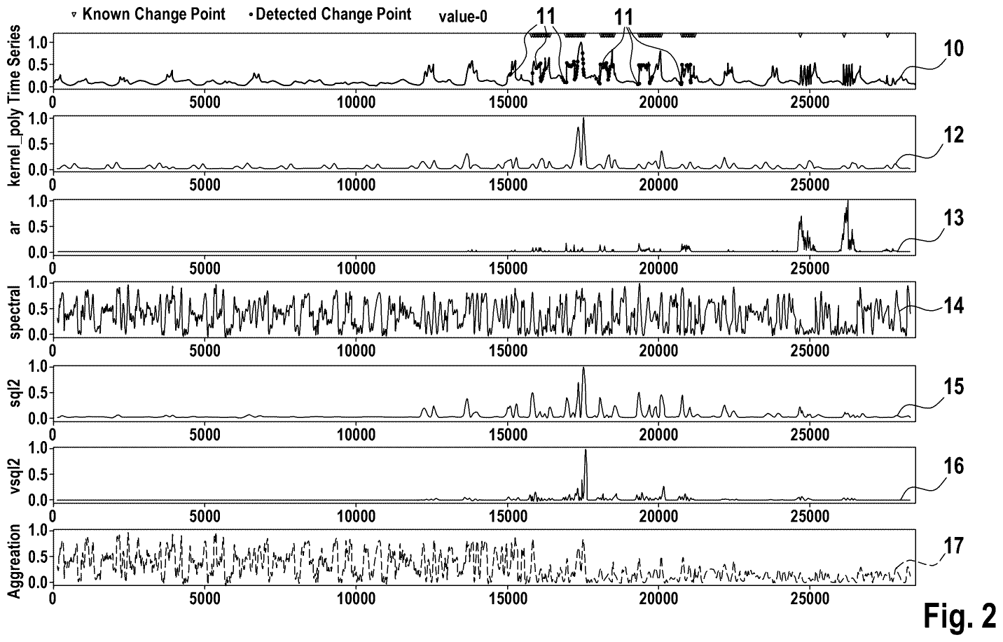

FIG. 2 illustrates part of a method for ascertaining at least one change point in a time series of sensor values according to embodiments of the present invention.

In particular, FIG. 2 shows the course of a time series of sensor values 10 over time, where the abscissa symbolizes time and the ordinate corresponding sensor values, and wherein change points 11 can also be identified.

In addition, FIG. 2 shows different characteristics 12, 13, 14, 15, 16 of the time series of sensor values 10, in particular a characteristic 12 based on kernel interpolation, a characteristic 13 based on regression analysis, a characteristic 14 based on a spectrum, a characteristic 15 based on the deviation from the mean value and a characteristic 16 based on the deviation from the variance. The abscissa represents time and the ordinate represents corresponding values.

Furthermore, FIG. 2 also shows a sum of the individual characteristics 12, 13, 14, 15, 16, or an aggregation 17 of the individual characteristics 12, 13, 14, 15, 16, where the abscissa again symbolizes time and the ordinate symbolizes corresponding values.

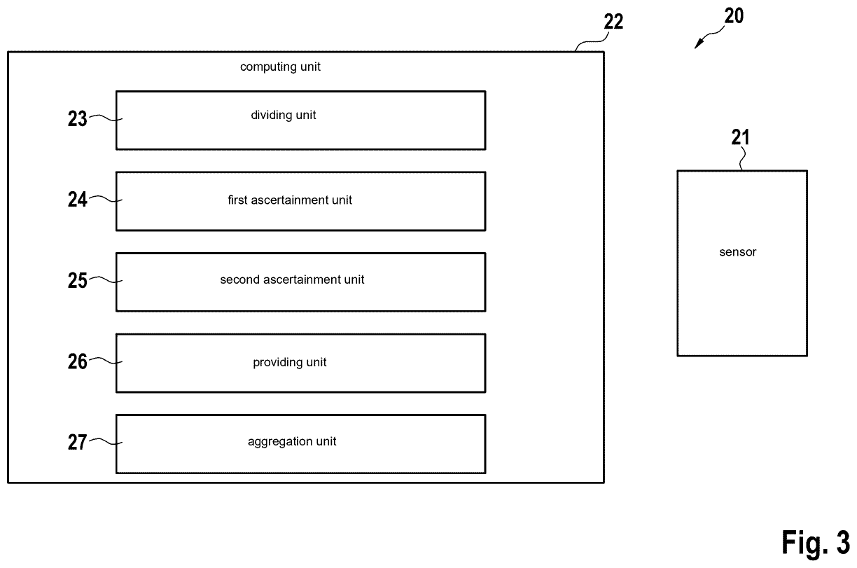

FIG. 3 shows a schematic block diagram of a system for ascertaining at least one change point in a time series of sensor values 20 according to embodiments of the present invention.

as shown in FIG. 3, the system 20 has a sensor 21 for detecting a time series of sensor values and a computing unit 22 for processing the time series of sensor values detected by the sensor 21.

As FIG. 3 further shows, the computing unit 22 further comprises a dividing unit 23, which is designed to divide the time series of sensor values into at least one evaluation window, a first ascertainment unit 24, which is designed to ascertain at least two different characteristics of the sensor values contained in the corresponding evaluation window for each of the at least one evaluation window, a second ascertainment unit 25, which is designed to ascertain for each of the at least one evaluation window, based on the at least two different characteristics of the sensor values contained in the corresponding evaluation window, whether the sensor values contained in the corresponding evaluation window have at least one change point, and a providing unit 26, which is designed to provide information about ascertained change points.

The dividing unit, the first ascertainment unit, and the second ascertainment unit can respectively be realized, for example, based on code which is stored in a memory and can be executed by a processor. The providing unit can also in particular be a transmitter designed to transmit corresponding information or data.

According to the embodiments of FIG. 3, the second ascertainment unit 25 is designed to compare information based on at least one of the at least two characteristics with at least one limit value.

According to the embodiments of FIG. 3, the second ascertainment unit 25 is also designed to apply a machine learning algorithm, which is trained to ascertain change points in information based on at least one characteristic of sensor values, to information based on at least one of the at least two characteristics.

As FIG. 3 shows, the system 20 shown also has an aggregation unit 27, which is designed to combine at least a part of the at least two different characteristics into a common characteristic, wherein the second ascertainment unit 25 is designed to ascertain, based on the common characteristic, whether the sensor values contained in the corresponding evaluation window have at least one change point.

In turn, the aggregation unit can, for example, be implemented on the basis of code which is stored in a memory and can be executed by a processor.

The illustrated ascertainment unit 25 is also designed to apply a standardization method to information based on at least one of the at least two characteristics.

The time series of sensor values is also a time series of sensor values detected during the execution of a manufacturing process and representing the manufacturing process.

In addition, the illustrated system 20 is designed to carry out a method described above for ascertaining at least one change point in a time series of sensor values.

1-11. (canceled)

12. A method for ascertaining at least one change point in a time series of sensor values, the method comprising the following steps:
providing a time series of sensor values and dividing the time series of sensor values into at least one evaluation window;
for each of the at least one evaluation window, ascertaining at least two different characteristics of the sensor values contained in the evaluation window;
for each of the at least one evaluation window, ascertaining whether the sensor values contained in the evaluation window have at least one change point based on the at least two different characteristics of the sensor values contained in the evaluation window; and
providing information about ascertained change points.

13. The method according to claim 12, wherein the step of ascertaining, for each of the at least one evaluation window, whether the sensor values contained in the evaluation window have at least one change point includes comparing information based on at least one of the at least two characteristics with at least one limit value.

14. The method according to claim 12, wherein the step of ascertaining, for each of the at least one evaluation window, whether the sensor values contained in the evaluation window have at least one change point includes applying a machine learning algorithm, which is trained to ascertain change points in information based on at least one characteristic of sensor values, to information based on at least one of the at least two characteristics.

15. The method according to claim 12, further comprising:
combining, for each of the at least one evaluation window, at least a part of the at least two different characteristics into a common characteristic, and wherein the step of ascertaining, for each of the at least one evaluation window, whether the sensor values contained in the evaluation window have at least one change point includes ascertaining whether the sensor values contained in the evaluation window have at least one change point based on the common characteristic.

16. The method according to claim 12, wherein the step of ascertaining, for each of the at least one evaluation window, whether the sensor values contained in the evaluation window have at least one change point includes applying a normalization method to information based on at least one of the at least two characteristics.

17. The method according to claim 12, wherein the time series of sensor values is a time series of sensor values measured during an execution of a manufacturing process and representing the manufacturing process.

18. A method for identifying anomalies in a manufacturing process, the method comprising the following steps:
during an execution of the manufacturing process, detecting a time series of sensor values representing the manufacturing process;
ascertaining at least one change point in the detected time series of sensor values by:
dividing the time series of sensor values into at least one evaluation window,
for each of the at least one evaluation window, ascertaining at least two different characteristics of the sensor values contained in the evaluation window,
for each of the at least one evaluation window, ascertaining whether the sensor values contained in the evaluation window have at least one change point based on the at least two different characteristics of the sensor values contained in the evaluation window, and
providing information about ascertained change points; and
examining the at least one change point in order to identify anomalies in the manufacturing process.

19. A system for ascertaining at least one change point in a time series of sensor values, the system comprising:
at least one sensor configured to detect a time series of sensor values; and
at least one computing unit for processing the detected time series of sensor values;
wherein the system is configured to ascertain at least one change point in the time series of the sensor values by:
dividing the time series of sensor values into at least one evaluation window,
for each of the at least one evaluation window, ascertaining at least two different characteristics of the sensor values contained in the evaluation window,
for each of the at least one evaluation window, ascertaining whether the sensor values contained in the evaluation window have at least one change point based on the at least two different characteristics of the sensor values contained in the evaluation window, and
providing information about ascertained change points.

20. A system for identifying anomalies in a manufacturing process, the system comprising:
at least one sensor configured to detect a time series of sensor values representing the manufacturing process during an execution of the manufacturing process;
an ascertainment unit configured to to ascertain at least one change point in the detected time series of sensor values, the ascertainment unit including at least one computing unit configured to:
divide the time series of sensor values into at least one evaluation window,
for each of the at least one evaluation window, ascertain at least two different characteristics of the sensor values contained in the evaluation window,
for each of the at least one evaluation window, ascertain whether the sensor values contained in the evaluation window have at least one change point based on the at least two different characteristics of the sensor values contained in the evaluation window, and
provide information about ascertained change points; and
an examination unit configured to examine the at least one change point in order to identify anomalies in the manufacturing process.

21. A non-transitory computer-readable medium on which is stored a computer program having program code for ascertaining at least one change point in a time series of sensor values, the program code, when executed by a computer, causing the compute to perform the following steps:
providing a time series of sensor values and dividing the time series of sensor values into at least one evaluation window;
for each of the at least one evaluation window, ascertaining at least two different characteristics of the sensor values contained in the evaluation window;
for each of the at least one evaluation window, ascertaining whether the sensor values contained in the evaluation window have at least one change point based on the at least two different characteristics of the sensor values contained in the evaluation window; and
providing information about ascertained change points.
